(19) United States
(12) Patent Application Publication
(10) Pub. No.: US 2013/0338863 A1
(43) Pub. Date: Dec. 19, 2013

(54) HYBRID VEHICLE CONTROL

(71) Applicants: Iva Shallvari, Troy, MI (US); Sashidhar Velnati, Oxford, MI (US); Kenneth P. DeGroot, Macomb Township, MI (US)

(72) Inventors: Iva Shallvari, Troy, MI (US); Sashidhar Velnati, Oxford, MI (US); Kenneth P. DeGroot, Macomb Township, MI (US)

(73) Assignee: CHRYSLER GROUP LLC, Auburn Hills, MI (US)

(21) Appl. No.: 13/523,943

(22) Filed: Jun. 15, 2012

(51) Int. Cl. B60W 20/00

(52) U.S. Cl. 701/22; 180/65.28; 903/902

(57) ABSTRACT

A method and powertrain apparatus for controlling a hybrid electric vehicle powertrain to maintain a catalyst within a catalytic converter at an efficient operating temperature while also maximizing the use of electric vehicle operating mode. The method and apparatus determine, during an electric vehicle operating mode, whether a catalyst efficiency is below a predetermined threshold and, if it is determined that the catalyst efficiency is below the predetermined threshold, suspend the electric vehicle operating mode and turn on the vehicle's engine to bring the catalyst efficiency to or above the predetermined threshold.

### GOVERNMENT INTEREST

This invention was made, at least in part, under U.S. Government, Department of Energy, Contract No. DE-EE0002720. The Government may have rights in this invention.

### FIELD

The present disclosure relates to a control method for a vehicle powertrain, and more particularly, to a method of controlling a hybrid electric vehicle powertrain based on a status of the vehicle's catalytic converter.

### BACKGROUND

Hybrid vehicles have been developed and continue to be developed to improve vehicle fuel economy and reduce vehicle emissions. Conventional hybrid electric vehicles (HEVs) combine internal combustion engines with electric propulsion systems. Plugin hybrid electric vehicles (PHEVs) share the characteristics of both conventional hybrid electric vehicles and all-electric vehicles by using rechargeable batteries that can be restored to full charge by connecting (e.g. via a plug) to an external electric power source.

Today, a vehicle's internal combustion engine is most likely connected to a catalytic converter, which contains a catalyst that converts the engine's toxic exhaust emissions into non-toxic substances such as carbon dioxide, nitrogen and water. These converters are known to be highly efficient once the catalyst is heated to a “light-off” temperature of e.g., several hundred degrees Fahrenheit.

Typically, it is a goal for a hybrid electric vehicle to operate in an electric mode (i.e., the vehicle is being propelled via electric motors while the engine is off) for as long as the high voltage battery maintains a certain charge. A problem exists, however, when the vehicle has been operating in the electric mode for an extended period of time. During an extended electric operating mode, the engine will be off, the catalyst within the catalytic converter will cool and its temperature may drop below an efficient operating point. A cooled-off catalyst will be ineffective and inefficient for converting the engine's toxic exhaust emissions into non-toxic substances when the engine is turned back on. Accordingly, there is a need for improvement in the art.

### SUMMARY

In one form, the present disclosure provides a method of controlling a hybrid electric vehicle. The method comprises determining, during an electric vehicle operating mode, whether a catalyst efficiency is below a predetermined threshold and, if it is determined that the catalyst efficiency is below the predetermined threshold, suspending the electric vehicle operating mode; and turning on a vehicle engine to bring the catalyst efficiency to or above the predetermined threshold.

The present disclosure also provides a powertrain apparatus for a hybrid electric vehicle. The apparatus comprises an engine, a catalytic converter including a catalyst, said catalytic converter connected to an exhaust of the engine; and a control unit for determining whether an efficiency of the catalyst is below a predetermined threshold during an electric vehicle operating mode and, if it is determined that the catalyst efficiency is below the predetermined threshold, the control unit suspends the electric vehicle operating mode and turns on the engine to bring the catalyst efficiency to or above the predetermined threshold.

In one embodiment, the engine is operated at an ignition timing corresponding to predetermined fuel consumption efficiency. In another embodiment, a fuel-to-air ratio of the engine is programmed and controlled for an optimal, predetermined catalyst efficiency.

In one embodiment, the catalyst efficiency predetermined threshold is determined by a temperature of the catalyst. The temperature of the catalyst can be determined using a model. The temperature of the catalyst can be determined by inputting a temperature from a temperature sensor.

Further areas of applicability of the present disclosure will become apparent from the detailed description and claims provided hereinafter. It should be understood that the detailed description, including disclosed embodiments and drawings, are merely exemplary in nature intended for purposes of illustration only and are not intended to limit the scope of the invention, its application or use. Thus, variations that do not depart from the gist of the invention are intended to be within the scope of the invention.

### BRIEF DESCRIPTION OF THE DRAWINGS

FIG. 1 illustrates a block diagram of a portion of a hybrid electric vehicle powertrain; and

FIG. 2 illustrates a method of controlling the hybrid electric vehicle powertrain of FIG. 1 in accordance with principles disclosed herein.

### DETAILED DESCRIPTION

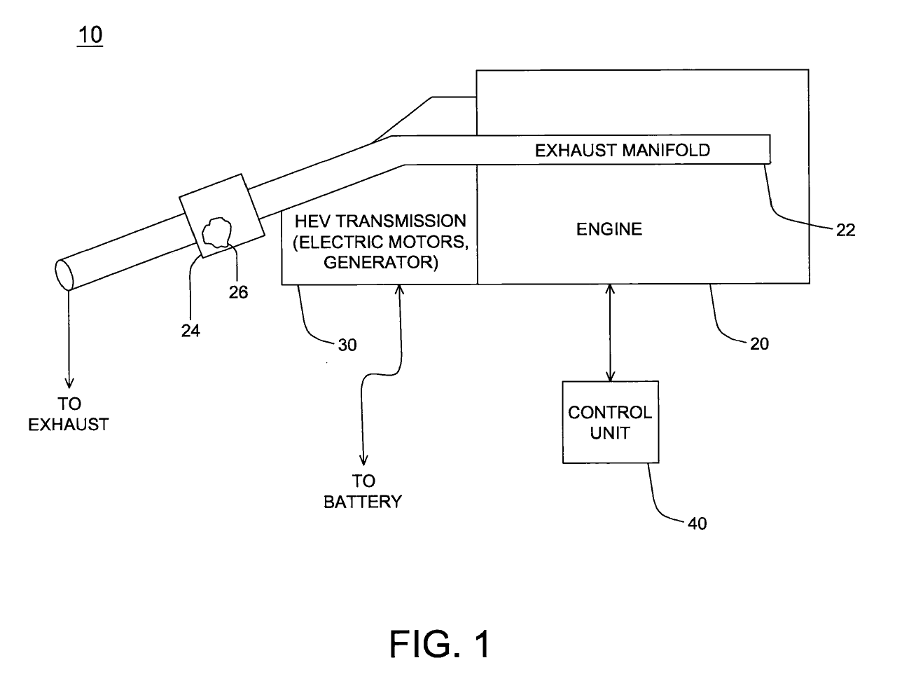

FIG. 1 illustrates a diagram of a portion of a hybrid electric vehicle powertrain 10. The hybrid electric vehicle can be e.g., a plug-in hybrid electric vehicle or other type of HEV. PHEVs usually operate in charge depleting or charge sustaining modes. The high voltage battery of the PHEV can be fully charged or “charge limited” (i.e., incapable of further charging). As is known in the art, the charge depleting mode typically allows a fully charged PHEV to favor power consumption from the electric power source until its battery state of charge (SOC) depletes below a predetermined level, at which time the vehicle's internal combustion engine is turned on. As is also known in the art, charge sustaining mode uses both of the vehicle's power sources to operate the vehicle as efficiently as possible and without allowing the high voltage battery state of charge to move outside a predetermined band.

The illustrated powertrain 10 includes an internal combustion (IC) engine 20 and a hybrid electric vehicle transmission 30, which includes at electric motors and an electric generator. The hybrid electric vehicle transmission 30 is connected to at least one high voltage battery, which powers the generator and thus the electric motors when the motors are in use. An exhaust manifold 22 is connected to the engine 20 and is used to expel exhaust gas from the engine 20 when the engine 20 is on. The exhaust gas is passed through a catalytic converter 24 that has a catalyst 26 for converting the engine's 20 toxic exhaust into non-toxic substances (e.g., carbon dioxide, nitrogen and water). Although not shown, the engine would also be connected to an air intake manifold, which allows air needed for fuel combustion to enter the engine 20.

A control unit 40 is operably connected to the engine 20 and the HEV transmission/electric generator 30 to control the various components of the powertrain 10, including start/stop functionality of the IC engine 20 and the placing of the vehicle in the desired operating mode. The control unit 40 may be a processor and may contain memory for storing computer instructions for carrying out the various functions performed by the control unit 40.

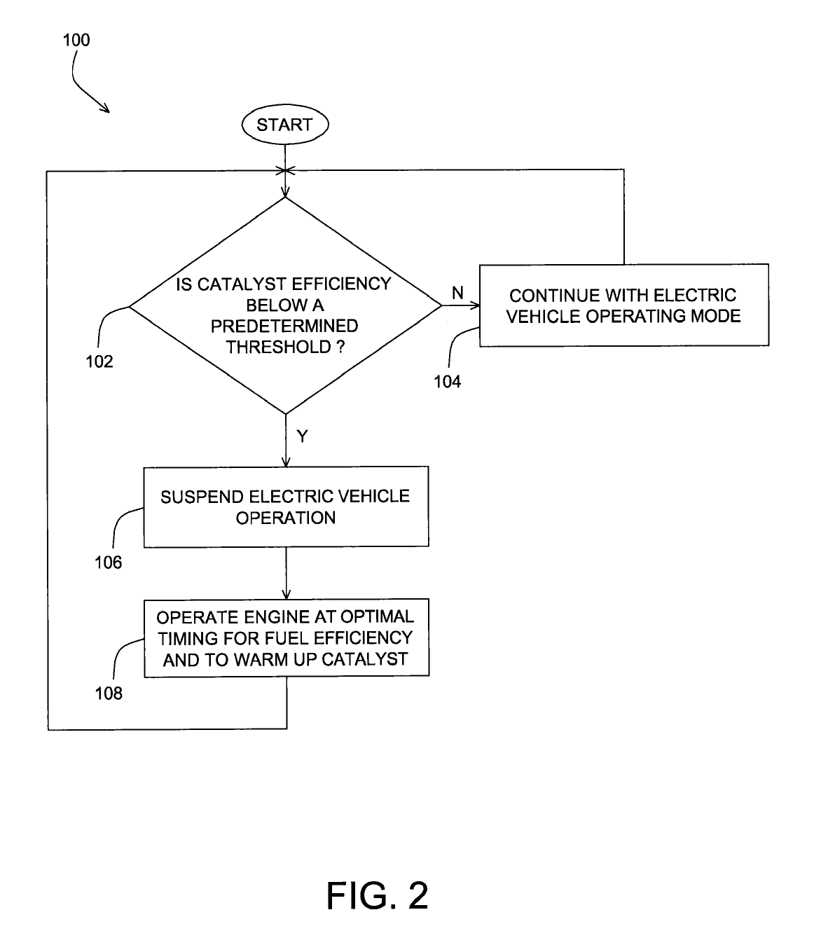

As noted above, it is desirable for the catalyst 26 to be heated to its “light-off” temperature to operate efficiently. As is also noted above, there are situations when the catalyst 26 temperature may drop below its “light-off” temperature while the vehicle is in operation (e.g., extended periods of electric vehicle operation, emissions testing, etc.), which could be problematic when the engine 20 is turned back on. As such, in accordance with the principles disclosed herein, the control unit 40 will be programmed to perform a method 100 (FIG. 2) for controlling the hybrid electric vehicle powertrain 10 in a manner that will maintain the catalyst 26 within a catalytic converter at a predetermined efficient operating temperature while also maximizing the use of the electric vehicle operating mode.

FIG. 2 illustrates the method 100 executed by the control unit 40. In a desired embodiment, the method 100 is implemented in software, stored in a computer readable medium, which could be a random access memory (RAM) device, non-volatile random access memory (NVRAM) device, or a read-only memory (ROM) device) and executed by the control unit 40. In a desired embodiment, the method 100 is executed while the vehicle is being operated in the electric vehicle operating mode (i.e., the charge depleting mode for a PHEV). The method 100 can be executed periodically, at a predetermined rate deemed suitable for success, as part of the control unit's 40 normal operating processing or background diagnostic processing.

The method 100 begins at step 102 where it is determined whether the efficiency of the catalyst 26 is below a predetermined threshold. In accordance with the disclosed principles, the efficiency of the catalyst 26 is determined by its temperature; as such, the predetermined threshold may be a temperature in which the catalyst 26 no longer effectively converts exhaust gas toxins into non-toxic substances (e.g., a temperature at or near the catalyst's 26 “light-off” temperature). In a desired embodiment, the temperature of the catalyst 26 is determined using a model executed by the control unit 40. The control unit 40 has knowledge of several parameters (e.g., time the engine has been off, speed of the vehicle, thermal hardware properties for the selected emission catalyst system) that could be input into a model and used to accurately determine the temperature of the catalyst 26 without additional equipment. Catalyst models are known in the art and any suitable model could be used at step 102.

Alternatively, the temperature of the catalyst 26 could be determined by a temperature sensor positioned on or within the catalytic converter 24. The sensor would be connected to the control unit 40, which would input signals indicative of the catalyst's 26 temperature from the sensor.

Regardless of how the catalyst 26 efficiency is determined, if it is determined that the efficiency is at or above a predetermined threshold (i.e., a “no” answer at step 102), the control unit 40 allows the vehicle to continue with the electric vehicle operating mode (step 104). If, however, it is determined that the catalyst efficiency is below the predetermined threshold (i.e., a “yes” answer at step 102), electric vehicle operation is suspended (step 106) and the engine 20 is turned on and operated at a predetermined ignition timing corresponding to a desirable, predetermined fuel consumption efficiency to warm the catalyst 26, until the catalyst efficiency is at or above its predetermined threshold (step 108).

It should be appreciated that optimization of the engine at step 108 could include optimizing various engine operating parameters such as the air-to-fuel ratio, causing the catalyst 26 to operate in a desirable manner, for example at predetermined temperature and efficiency. In addition, or alternatively, the spark timing of the engine at step 108 could be slowed down (often referred to as spark retard) to optimize the heating of the catalyst 26 to react optimally. The control unit 40 leaves the engine on long enough to achieve optimal catalyst efficiency. Once the desired catalyst efficiency is achieved, the control unit 40 can initiate the electric vehicle operating mode again. One additional benefit is achieved because the high voltage battery can be simultaneously charged while the engine 20 is on to warm up the catalyst 26. Thus, two hybrid objectives are accomplished at the same time. It is contemplated the optimization may include consideration of factors such as engine and electric systems/components configuration, environment factors, emissions and fuel factors, and other vehicle parameters. The optimization may further include a weighting of various parameters for desirable component, system and/or vehicle performance and efficiencies.

It should be appreciated that the process to warm up the catalyst can be initiated automatically without the need for a driver action. In addition, the method 100, particularly steps 106 and 108 can be initiated with other “engine on” events such as a rapid acceleration and enabling of auxiliary loads (including the HVAC system, etc.). It should be appreciated that the operation of the method 100 may be transparent to the driver no matter how the method 100 is carried out. That is, the output torque and speed requirements may seem like normal engine on scenarios experienced by the driver when driving a hybrid electric vehicle.

1. A method of controlling a hybrid electric vehicle capable of using an electric operating mode that provides power without using a gas-powered engine of the vehicle, said method comprising:
determining by a control unit, during operation of the vehicle in the electric vehicle operating mode, whether a catalyst efficiency is below a predetermined threshold; and
if it is determined that the catalyst efficiency is below the predetermined threshold, the control unit is used for:
suspending the operation of the electric vehicle operating mode; and
turning on the vehicle engine to bring the catalyst efficiency above the predetermined threshold.

2. The method of claim 1, further comprising operating the engine at an ignition timing for optimal fuel consumption efficiency.

3. The method of claim 1, further comprising programming and controlling a fuel-to-air ratio of the engine for optimal catalyst efficiency.

4. The method of claim 1, wherein determining whether the catalyst efficiency is below the predetermined threshold includes comparing a temperature of the catalyst to the threshold, which is a temperature.

5. The method of claim 4, further comprising using a model to determine the temperature of the catalyst.

6. The method of claim 4, further comprising inputting a temperature from a temperature sensor to determine the temperature of the catalyst.

7. The method of claim 4, further comprising operating the engine until the temperature of the catalyst rises above the threshold.

8. A powertrain apparatus for a hybrid electric vehicle, said apparatus comprising:
an engine;
a catalytic converter including a catalyst, said catalytic converter connected to an exhaust of the engine; and
a control unit for determining whether an efficiency of the catalyst is below a predetermined threshold during an electric vehicle operating mode that provides power without using a gas-powered engine; and if it is determined that the catalyst efficiency is below the predetermined threshold, the control unit suspends the electric vehicle operating mode and turns on the engine to bring the catalyst efficiency above the predetermined threshold.

9. The powertrain apparatus of claim 8, wherein the engine is operated at an ignition timing for optimal fuel consumption efficiency.

10. The powertrain apparatus of claim 8, wherein a fuel-to-air ratio of the engine is programmed and controlled for optimal catalyst efficiency.

11. The powertrain apparatus of claim 8, wherein the predetermined threshold is a temperature of the catalyst and the catalyst efficiency is determined by comparing a temperature of the catalyst to the threshold.

12. The powertrain apparatus of claim 11, wherein the temperature of the catalyst is determined using a model.

13. The powertrain apparatus of claim 11, wherein the temperature of the catalyst is determined by inputting a temperature from a temperature sensor.

14. The powertrain apparatus of claim 11, wherein the engine is operated until the temperature of the catalyst rises above the threshold.
